(19) United States
(12) Patent Application Publication
(10) Pub. No.: US 2003/0167191 A1
(43) Pub. Date: Sep. 4, 2003

(54) System and method for underwriting review in an insurance system

(76) Inventors: Elizabeth Ann Slabonik, Boyertown, PA (US); Steven Russell Plumb, Harleysville, PA (US); Linda Vaughan Cooper, Trappe, PA (US); Jennifer Suzette Harwell Payne, Lansdale, PA (US); Gail Frances Mayer, Lansdale, PA (US)

Correspondence Address: Drinkder Biddle & Reath LLP, One Logan Square, 18th & Cherry Streets, Philadelphia, PA, 19103-6996, US

(21) Appl. No.: 10/082,793

(22) Filed: Feb. 25, 2002

(51) Int. Cl. G06F 17/60

(52) U.S. Cl. 705/4

(57) ABSTRACT

A method of centralized automated underwriting of an insurance policy, and a centralized automated underwriter, are disclosed. The method may include intaking the plurality of applicant information, applying, in parallel, and to a normalized plurality of applicant information, at least two primary executable rules, generating a report log of results of the rules applying, wherein the report log includes at least one flag of at least one of the plurality of applicant information, and referring, in accordance with the at least one flag, of at least one of the flagged at least one of the plurality of applicant information, to at least one hierarchical underwriter. The centralized underwriter includes an intake that intakes a plurality of applicant information in an intake format, a rules applicator that selectively applies, to the standard format of the plurality of applicant information, and in accordance with at least two parameters of the plurality of applicant information, at least two primary executable rules, wherein the policy is referred, in accordance with the at least one flag of at least one parameter, to at least one hierarchical underwriter.

### FIELD OF THE INVENTION

The present invention relates to an insurance policy underwriting process, and in particular relates to providing underwriting screening and review using an underwriting system, thereby reducing manual underwriter involvement with the review process.

### BACKGROUND OF THE INVENTION

Determination, by an insurer, of willingness to insure an applicant is typically dependant upon the risks associated with that applicant. Assessment of these risks may be accomplished through review of applicant information by an insurance company employee, or an affiliate of the insurer, herein referred to as an “underwriter”. Thus, the underwriter may consider factors that characterize the applicant in terms of the risks associated with providing insurance to the applicant.

In order to standardize assessments of the desirability of providing insurance to an applicant, the insurance company may provide underwriters with guidelines for assessing risks associated with applicants. These guidelines may, for example, provide for three categories of responses that may be described as do not insure, consider further, and insure. If an applicant characteristic falls within a do not insure guideline, such as, for example, wherein an applicant applies for auto insurance, and has had 8 accidents in the last six months, the underwriter is instructed to refuse the application. If an applicant characteristic falls within the consider further class, the underwriter may review the specifics of an applicant characteristic further. For example, an underwriter may be instructed to further consider an applicant who has been involved in an accident within the previous three years, in order to, for example, determine whether the applicant was at fault. If the underwriter determines that the applicant was not at fault, the underwriter may determine that the applicant is insurable. If an applicant characteristic falls within the insure class, the underwriter may be instructed to review additional characteristics in order to decide whether the applicant qualifies for a policy, in order to elect a tier for the applicant, in order to modify coverage of a policy, or to move the policy to issuance.

A determination of whether an applicant is insurable generally necessitates a review of multiple characteristics of the applicant. These characteristics may include, for example, information particular to a specific type of coverage, such as applicant's accident history for an automobile policy, and/or information generic to different types of coverage, such as applicant age or residence.

Additionally, insurance policy types may include several sub-types. For example, an insurer may write homeowners policies in more than one state, and/or different types of policies within each state, and these different types may be dependent upon the agent writing the policy. Further, different categories of coverage may exist within policy types, such as wherein a risk factor of 1-5, for example, is assigned to a driver to whom an auto policy is to be issued, based upon age and previous driving record. Further, within each policy type, the underwriter may be required by the insurer to set tiers, wherein such tiers may define price quotes or premiums associated with a policy. Tiers may, for example, be directed towards the provision of premium services, such as the inclusion of towing services in an automobile policy. Due to the fact that each policy type may have differing guidelines for insurability, or levels of insurability, an underwriter may be confronted with a large number of insurability guidelines that must be recalled and properly and consistently applied.

The ability of an underwriter to review and assess an application is dependant upon the number of guidelines that must be considered, and the number of applications that must be processed. Accordingly, as greater numbers of guidelines are imposed, a greater amount of time must be applied by an underwriter to a given application, thereby reducing the number of applications that can be considered by the underwriter in a given amount of time, and thereby reducing the consistency with which the underwriter may apply the guidelines.

However, the greater the number of guidelines that an insurer provides, the more the risk associated with an insured can be managed, thereby better allowing the insurer to maintain profitability. For example, simply creating low “do not insure” thresholds may reduce the pool of applicants for which policies are written, thus requiring greater profitability on the fewer policies written. Accordingly, providing a greater number of guidelines allows an insurer to maximize the number of insureds, while still managing the risk associated with each of the insureds.

Nonetheless, attempting to balance the insurer's need to have a large number of guidelines, against the inefficiency associated with providing underwriters with a large number of guidelines, often results in sub-optimal policy review and issuance. For example, the expense of providing sufficiently trained underwriters to quickly and thoroughly review applications is applied against the improvement gained therefrom in number of applications, and quality of insureds, and may thereby cause a decrease in profitability of the insurer. On the other hand, if guidelines are minimized, thereby allowing exposure to undesirable risk, profitability of the insurer may be negatively impacted by an increase in payouts to insureds.

Further, guidelines applied by an insurer may accommodate changing regulations, as guidelines may vary with changing business goals on which the guidelines are based. Actuaries may be generally employed by insurers to allow statistical estimation of risk associated with various characteristics, and thus to assist in generating the business goals. As the statistical estimations created by the actuaries change, the changes are incorporated into the guidelines used by the underwriters. An insurer may also desire to change guidelines in order to address marketing concerns. Publishing changes to the guidelines for underwriters may create unwanted administrative expenses, as well as reduce the efficiency of underwriter review.

As applications are received by an insurer for consideration, the applications may be disseminated among available underwriters for consideration. Different applications may, however, take different amounts of time for consideration. In addition, the response time on the application may be delayed by a backlog of applications at an assigned underwriter, or by unavailability of the underwriter due to, for example, illness or vacation. Such delays may cause customer dissatisfaction.

Therefore, the need exists for an underwriting system that processes policies in an expeditious and consistent manner, and that does so in a substantially equivalent time period for multiple policy types.

### SUMMARY OF THE INVENTION

The present invention includes a method of centralized automated underwriting of an insurance policy in accordance with a plurality of applicant information. The method may include intaking the plurality of applicant information, normalizing the plurality of applicant information, applying, in parallel, and to the normalized plurality of applicant information, at least two primary executable rules, wherein the normalized plurality of applicant information comprises at least two parameters for the at least two primary executable rules. The method may additionally include generating a report log of results of the rules applying, wherein the report log includes at least one flag of at least one of the plurality of applicant information, and referring, in accordance with the at least one flag, of at least one of the flagged at least one of the plurality of applicant information, to at least one hierarchical underwriter.

The method may additionally include, upon detection of the refer for further consideration flag, referring to a hierarchical automated underwriter. This hierarchical referring may include applying by the hierarchical automated underwriter to the normalized plurality of applicant information correspondent to the at least one refer for further consideration flag, at least one secondary executable rule, wherein the normalized plurality of applicant information comprises at least one parameter for the at least one secondary executable rule.

The present invention additionally includes a centralized automated underwriter for an insurance policy. The centralized underwriter includes an intake that intakes a plurality of applicant information in an intake format, a normalizer that normalizes the intake format of the plurality of applicant information into a standard format of the centralized automated underwriter, a rules applicator that selectively applies, to the standard format of the plurality of applicant information, and in accordance with at least two parameters of the plurality of applicant information, at least two primary executable rules, a report generator that generates a report log of results from the rules applicator, wherein the report log includes at least one flag of at least one parameter of the plurality of applicant information, and wherein said report generator refers, in accordance with the at least one flag, at least one of the flagged at least one parameters, to at least one hierarchical underwriter.

Thus, the present invention provides an underwriting system that processes policies in an expeditious and consistent manner, and that does so in a substantially equivalent time period for multiple policy types.

### BRIEF DESCRIPTION OF THE FIGURES

Understanding of the present invention will be facilitated by consideration of the following detailed description of an embodiment of the present invention taken in conjunction with the accompanying drawings, in which like numerals refer to like elements, and wherein:

FIG. 1 illustrates an exemplary process flow for assisting underwriter review in an insurance sales system;

FIG. 2 illustrates an exemplary process for receiving applicant information in an insurance sales process;

FIG. 3 illustrates an exemplary process for standardizing data in an insurance sales process;

FIG. 4 illustrates an exemplary data block using tagged field coding in a process for assisting underwriter review in accordance with the present invention;

FIG. 5 illustrates exemplary formatted rules for use in association with executable rules in a process for assisting underwriter review in accordance with the present invention;

FIG. 6 illustrates an exemplary process for applying underwriting rules to standardized data in an insurance sales process;

FIG. 7 illustrates an exemplary process for underwriter referral which may be invoked when application of the rules results in a “further consideration” determination;

FIG. 8 illustrates an exemplary process for underwriter review escalation in an insurance sales process; and

FIG. 9 illustrates an exemplary insurance sales system according to the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, some elements that are either known to those of skill in the art or inconsequential to the present invention. Those of ordinary skill in the art will recognize that other elements may be necessary and/or desirable in conjunction with the present invention. However, because such elements do not facilitate a better understanding of the present invention, a discussion of such elements is not provided herein.

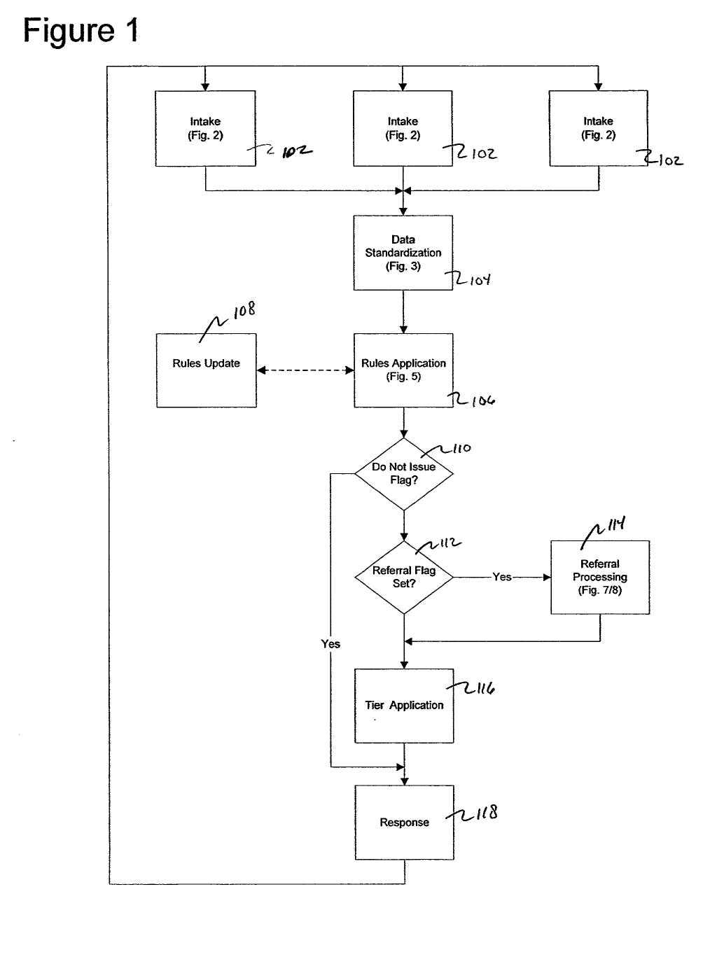

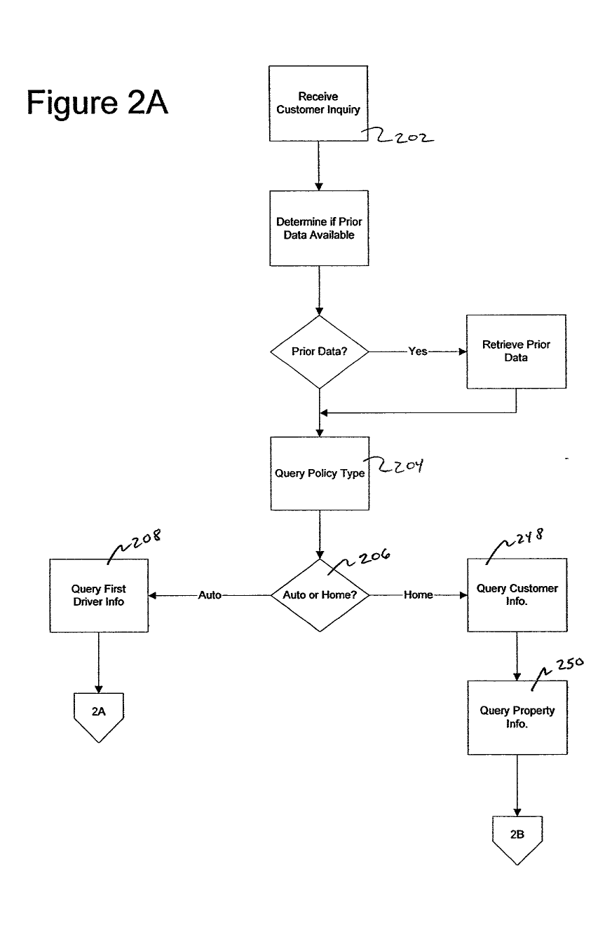

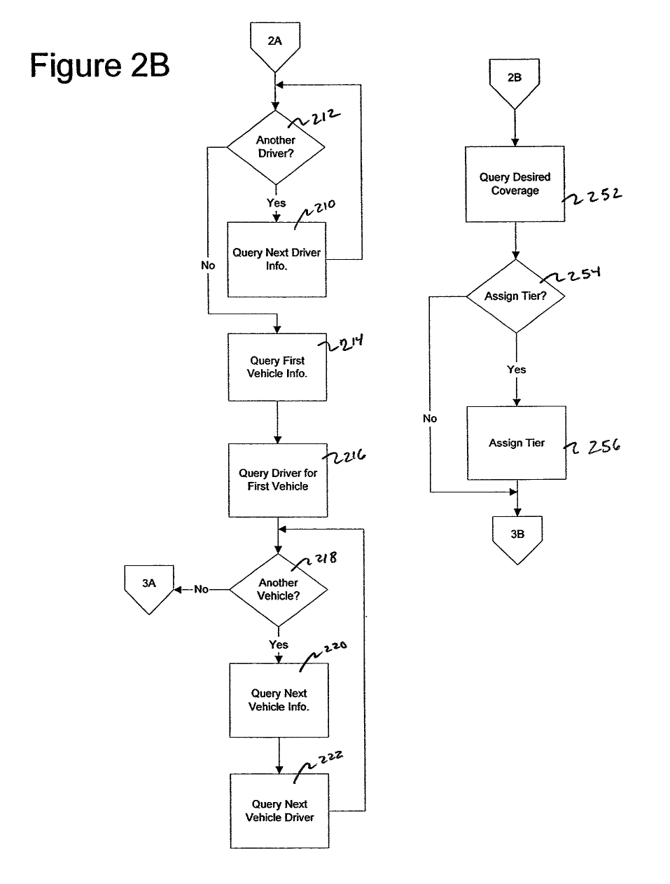

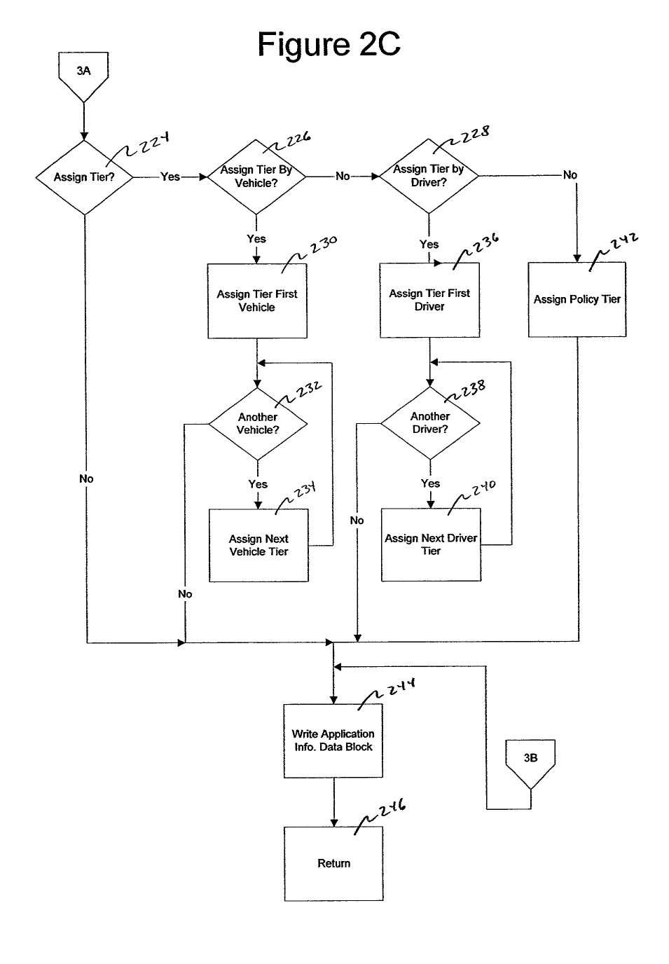

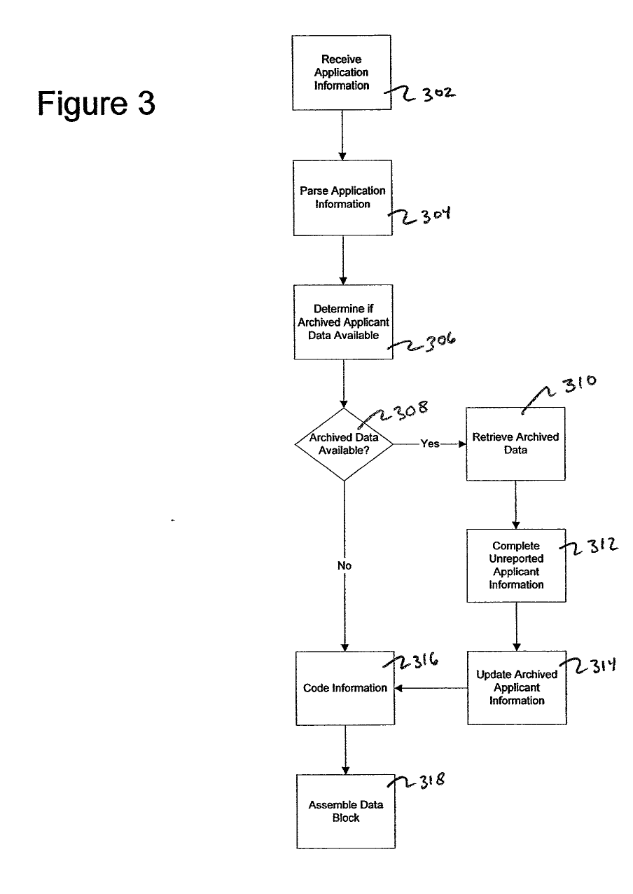

FIG. 1 is a flow diagram illustrating an exemplary process flow for automated underwriter review in a sales system. As shown in FIG. 1, a basic process for assisting underwriters in the consideration of applications may begin by the intake 102 of an applicant's information. Intake 102 is discussed further hereinbelow with respect to FIG. 2. Intake may typically be accomplished by independent sales agents or brokers, through insurance company employees, or through a networked application point, such as through an Internet web site, intranet site, or direct dial access point. Each intake point may employ differing formats for receiving and storing information from an applicant. The data in the intake preferably includes information required by an insurer for consideration of an application. Intake may include entry of the data into at least one applicant database. Each applicant may be entered into a database unique to that applicant, or a plurality of applicants may be entered into a single database. As different formats may be used by different intake points, the data may be standardized or normalized 104 into a single format, to thereby allow for simplified and/or expedited consideration by the insurer and/or placement into the database field(s). Standardization 104 is described further with respect to FIG. 3, hereinbelow.

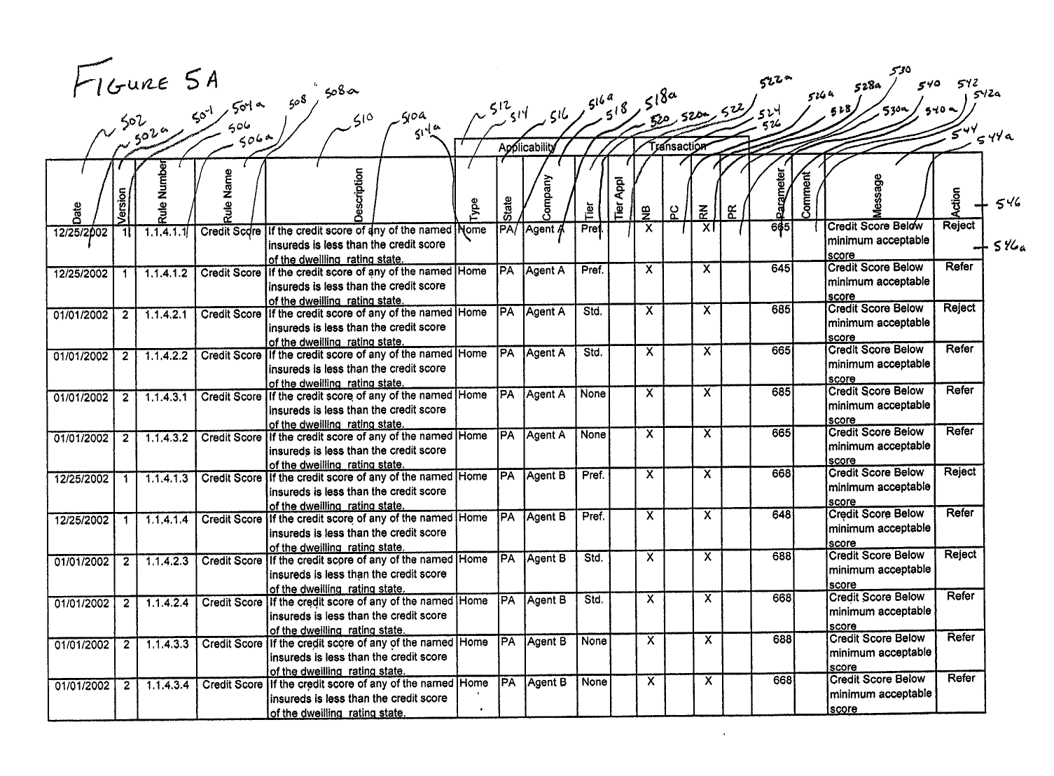

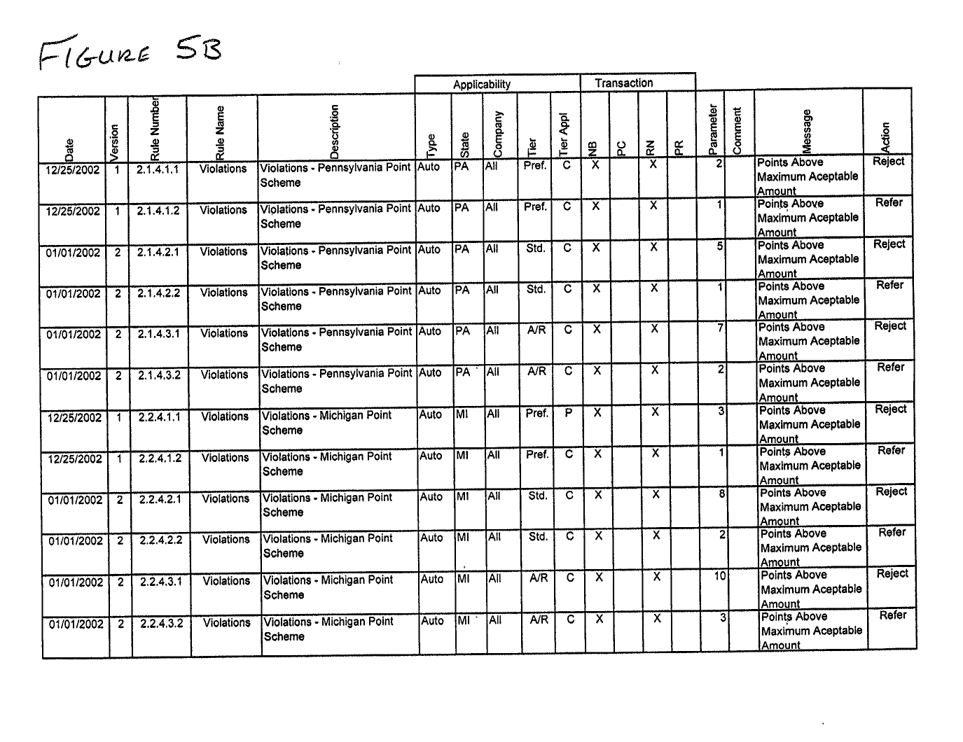

Upon standardization, underwriting guidelines (hereafter referred to as “rules”, or “business rules”) may be applied 106 to the application data, such as shown in FIG. 5, discussed further hereinbelow. Rules may be in the form of an expert system, wherein processing of the rules may be conducted more efficiently than with standard linear programming, such as through the use of relational or object-oriented programming, in series or in parallel. Additionally, rules may be implemented using variables or parameters within the rules, as discussed further with respect to FIG. 5 hereinbelow, such that the impact of the rule may be altered without reprogramming that rule or other rules. The variables alone may be updated 108, as necessary, as discussed further hereinbelow. The modular nature of the rules allows for minor modification to individual rules, without effecting other rules, such that large-scale reprogramming is unnecessary to implement multiple rule changes.

Application 106 of the rules may create a report log evidencing the results of the application of the rules to information submitted by the applicant through intake 102. The log may include a result of the application of each rule applied to the information in the application. Alternatively, the report log may only identify rules for which a predetermined result is generated, such as a “refer for further consideration” determination or “flag”. Alternatively, if one or more rules provide the predetermined result, such as the “refer” result, one or more flags indicating the presence of these results may be set. Likewise, “do not insure” results may cause flags to be set indicating the presence of one or more “do not insure” determinations. Flags may identify the rule that generated the “refer” result, thereby allowing a hierarchical or manual underwriter to which the application is referred to focus on the particular aspect of the application information which caused the flag to be set. Finally, flags may or may not be set for “insure” determinations, since an “insure” result may not necessitate further review from an underwriter.

From the report log, it may be determined 110 whether any flags, such as “do not insure” flags, have been set. Due to the fact that “do not insure” flags indicate that an applicant should not be insured according to the underwriting guidelines, the application may be transferred to response step 118 upon detection of a “do not insure” flag, for generation of a response to the applicant or intake agent indicating that the policy will not be written.

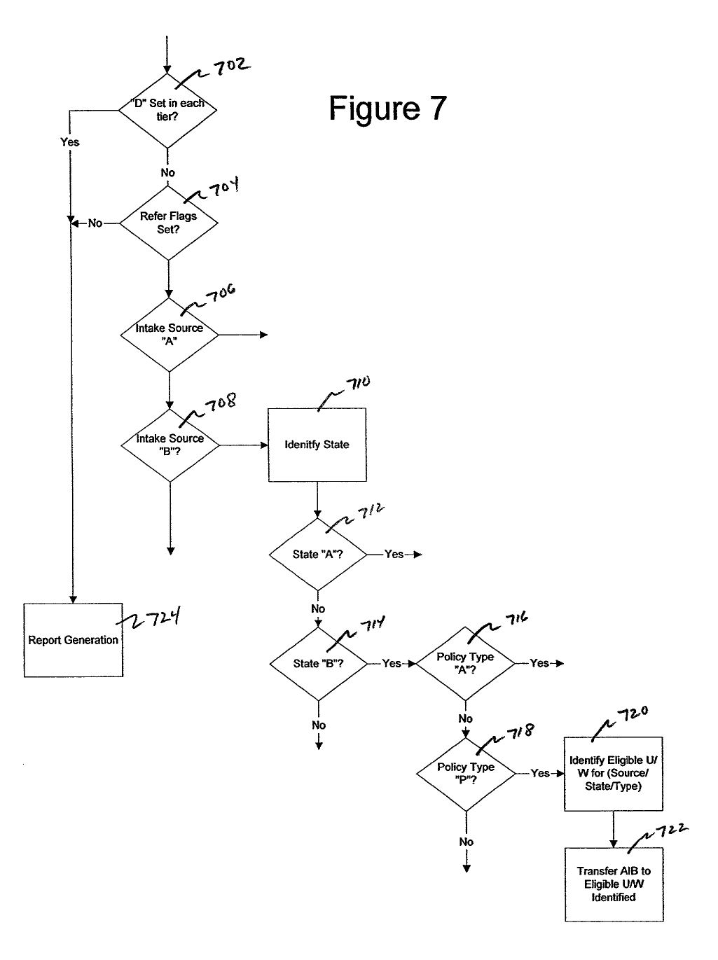

Additionally, from the report log, it may be determined 112 whether at least one “consider further” flag, indicating that the application should be referred to a hierarchical automated underwriter, or to a manual underwriter, has been set. If such a flag has been set, the process may refer consideration of the application information to a hierarchical automated underwriter, or to a hierarchical manual underwriter. For example, the automated underwriter of the present invention may be organized in a hierarchical manner, wherein the first level assesses the simplest applications, and wherein a less-simplistically assessed application, i.e. an application in which at least one “consider further” is set, is passed to the secondary underwriter for a more intricate review of, in particular, the “consider further” flag(s), using at least one more detailed secondary rule. It will be apparent to those skilled in the art that additional hierarchical levels may be included, and that these hierarchical levels may process in series, or in parallel, with the first level of the hierarchy, and with other hierarchical levels. This process is discussed further with respect to FIG. 7, hereinbelow.

In addition to forwarding “refer” flagged application information to a hierarchical underwriter, application of the rules may be used to determine the sufficiency of the data provided, such that provision of incomplete or invalid data results in referral of the applicant information to an automated or manual technician to assist in resolution of the discrepancy. Alternatively, identification of a discrepancy may be handled at data standardization 104, and may include referral for resolution of the discrepancy to the agent responsible for the applicant information intake. Additionally, the applicant information may itself be used to select which rules are applied to the applicant information.

If an underwriter to which the application has been referred determines that the applicant may be insured, or if application of the rules yields an “insure” result, the application information may be assigned to the tiering process 116. Tiering 116 of an application may entail assignment of a requested policy into a tier for that product. Alternatively, a preliminary tier may be generated at intake, either by the applicant, the agent, or in accordance with selected applicant information upon entry. As noted hereinabove, tiers within a policy level, or within a vehicle level, such as standard, preferred, elite, or premier, may be based on applicant characteristics, or the provision of policy add-ons, based on the characteristics of the applicant. For example, within available auto insurance products, there may be different levels or tiers of coverage, benefits of policies, and rates based on, for example, a candidate's driving record, insurance credit score, prior history with the company, other policies held, and the like. In the instance wherein the intake source preliminarily selects a tier for an applicant, the preliminary tier information is preferably forwarded to the centralized underwriter with the other application information.

Tiering of an application may include comparing, by a comparator, of the applicant data and/or report log to a tier characteristic database, in order to determine the highest service level, or additional benefits package, that may be associated with that policy, or the lowest pricing structure that may be associated with that application. Tiering 116 may additionally incorporate distinctions between jurisdictions and/or policies, and thus is preferably guideline based, such that variables and/or parameters are used which may be updated without recourse to reprogramming a tool being used to apply the re-tiering guidelines or rules, such as the comparator or tier characteristic database. Tiering may be performed in series or in parallel with the remaining elements of the method of the present invention.

Upon application of the rules, and following underwriter referral and/or tiering, a response indicating the desirability of issuing insurance to the applicant may be generated 118. The response may reflect an insure/do not insure decision, as well as identify any pricing associated with a policy that the insurer is willing to provide. Once a response has been generated 118, the review process may be initiated for another applicant, starting at intake. Although the process is illustrated above as a serial process, application data may be considered concurrently, in parallel, such as by an object-oriented methodology, such that, for example, a first application is being standardized, while a preceding application is having underwriting rules applied thereto, or, while the first application is being checked for age and gender flags, that first application is simultaneously being checked for residence state flags. Further, multiple applications may be under consideration by underwriters or technicians, or by a hierarchical underwriter, such as an automated or a manual underwriter, concurrently.

By removing “do not insure” and “insure” application information from manual underwriter consideration, the number of manual underwriters necessary to allow for consideration of a given number of applications may be reduced. Accordingly, greater numbers of guidelines related to borderline issuance cases may be provided in a centralized automated evaluation of an application, and involved manual underwriters may focus only on specific aspects of application information that are flagged for additional review. A resulting decrease in the time required for underwriting personnel to consider application information may thereby result. It is currently estimated that at least a 3 fold increase in the number of policies generated by a constant number of manual underwriters may be achieved using the present process. Further, it is an advantage of the process hereinabove that rule changes are easily made by the direct input of updated variables or modular commands, thereby saving human resources costs in implementing changes. Additionally, the ability of the process to tier the risk of, or grade the risk of, a new insurance application, based on client specific and policy information, may relieve underwriting personnel of this task, and will more easily and consistently establish tiers and rates for applications.

FIG. 2 is a flow diagram illustrating an exemplary process for receiving applicant information in an insurance process. As shown in FIG. 2, the intake process may be initiated by receipt 202 of a request for insurance from an applicant. Although the term applicant is used herein, the term additionally encompasses entities desiring to obtain rate quotes, as well as entities seeking to be insured, and includes commercial entities, similarly grouped entities, and individuals. Upon receipt of a request, it may be determined 204 the type of policy, and/or the tier of policy, that is desired. Herein, by way of example, auto and homeowners policies are illustrated, although it will be apparent to those skilled in the art that other insurance types may be similarly implemented by use of the present invention. Further, the term “homeowners” is not limited herein to entities owning residential properties, but may include renters or Teasers, as well as business owners or other entities seeking property based insurance.

If it is determined 206 that an auto policy is being requested, the applicant may be queried 208 to identify a first driver, or a first car, to be insured. The query will preferably determine pertinent information necessary to identify a subject driver for consideration of the provision of an insurance policy. Once the first driver to be insured has been identified, the applicant may be queried 210 to identify additional drivers and/or vehicles desired to be insured, until it is determined 212 that no additional drivers and/or vehicles are to be included within the desired policy. The applicant may be queried 214 to identify a first vehicle to be covered under the requested policy, and may additionally be queried 216 to determine a driver associated with the first vehicle. It may also be determined 218 whether additional vehicles are desired to be covered under the policy, and the applicant may be queried 220 to provide necessary information for each subsequent vehicle.

The intake source, such as an insurance agent, may assign a preliminary tier to a policy request. If it is determined 224 that a tier is proposed, either by the agent or the applicant, consideration of the applicant data by the insurer may be initially based on the proposed preliminary tier. Assignment of a proposed tier may be accomplished by first determining 226 whether coverage can be, or is desired to be, tiered, such as by vehicle. If tiering is to be by vehicle, the preliminary tier may be assigned 230 to a first vehicle. If it is determined 232 that another vehicle is included in the application, the preliminary tier may be assigned 234 to each subsequent vehicle, or a different preliminary tier may be accepted for each subsequent vehicle. If it is determined 228 that a preliminary tier is to be assigned by driver, a preliminary tier may be assigned 236 to the first driver. Tiers may be then assigned 240 to subsequent drivers in substantially the same manner as discussed hereinabove with respect to vehicle tiering. If tiering is not to be by vehicle or by driver, an alternative preliminary tier, such as by age, may be assigned 242 to a requested policy. Once all preliminary tiering has been completed, the acquired information may be transmitted 244 from the intake source, or may be manipulated by the central underwriter, such as in an embodiment wherein preliminary tiering is generated at the central underwriter. The intake source may then 246 to await a next application request.

The intake process may include an Internet accessible intake screen, such that an applicant, or agent, is queried to determine necessary information through a web interface. Wherein a web interface is utilized, the web interface may be hosted by the insurer, such that information obtained with respect to an applicant may be received directly by the insurer via entry by the agent, and such that an agent is not required to affirmatively transmit the data to the insurer. Alternatively, the web interface may be hosted by an agent, or by a third party.

If it is initially determined 206 that an applicant desires homeowners insurance, or information pertaining thereto, the applicant may be queried 248 to identify the applicant, and queried 250 for information identifying the property desired to be insured. Additionally, the applicant may be queried 252 to determine the coverage desired. A tier may be proposed for the applicant. If it is determined 254 that a tier is to be proposed for an applicant, the intake source may assign 256 a tier to the application automatically, such as by a preliminary determination using selected data entered by, or on behalf of, the applicant. Once applicant information has been obtained, the information may be electronically transmitted 244 by the intake source to the insurer. Similarly to the automobile insurance discussed hereinabove, alternative intake forms, such as Internet accessible intake interfaces, may be utilized to accomplish the intake process.

FIG. 3 is a flow diagram illustrating an exemplary process for standardizing data in an insurance sales process. As shown in FIG. 3, once the information has been received 302 by the insurer, the information may be parsed 304 to identify elements of the received information. In addition to the raw data provided by the applicant, the insurer may need the context of the data, or of the data entry. For example, the insurer may need information regarding the data entry methodology, such as by PDF or html file, the data entry program, such as Adobe or Internet Explorer, or the order of data entry, such as which of two names provided by an applicant is the applicant's last name, or which driver identified is associated with which vehicle identified. Such associations can be accomplished by using field codings, and data type codings, for the information received from known input methodologies. These known methodologies may be assigned to a particular intake point upon registration, and may be entered into, for example, a database, wherein the database is compared against incoming information in order to identify the intake point, and thereby identify the intake methodology and/or data structure.

The parsed data may then be assembled 318 into a common format data structure for all policies to be considered. Accordingly, the common structure may include fields particular to each type of policy being offered, such that fields not associated with a particular coverage may be left empty. Fields associated with the desired coverage may be completed, in accordance with a standard format, wherein the parsed information from the intake data is placed into the fields of the standard format. Additionally, archived information associated with a repeat applicant may be retrieved 310 to assist in completion of the data structure, and new data received may be used to update archived information regarding an applicant. For example, the system of the present invention may include at least one applicant and/or insured database for prior applicants, and/or prior or current insureds, wherein information entered previously by the prior applicant is stored for future use at a time when the present applicant is identified as a prior applicant, such as by a cookie, password, IP address, or the like. Information in the at least one historical database is preferably accessible in the standardized format for use with newly entered information in any manner apparent to those skilled in the art.

Application information may also be coded 316 in accordance with the desired coverage, to thereby facilitate use with the historical database. In addition to coding the application information for policy type, policy actions may be associated with application information. For example, application information may be coded in accordance with whether the request is for new business (hereinafter referred to as “NB”), a policy change (hereinafter referred to as “PC”), a renewal (hereinafter referred to as “RN”), or a pre-renewal (hereinafter referred to as “PR”), for example. PR's may differ from RN's in that a policy may be automatically created upon acceptance of an RN application, while a PR application may be presented to an applicant for consideration before a policy is entered.

Standardized application information may preferably be assembled 318 into an application information block suitable for forwarding to a rule server, as discussed hereinabove with respect to FIG. 1. Application information within the application information block may be formatted, for example, in a fixed field structure, such as a data structure or object employing C++, JAVA, or the like, or may be formatted using tagged fields to thereby allow recognition of the import of data contained in a field.

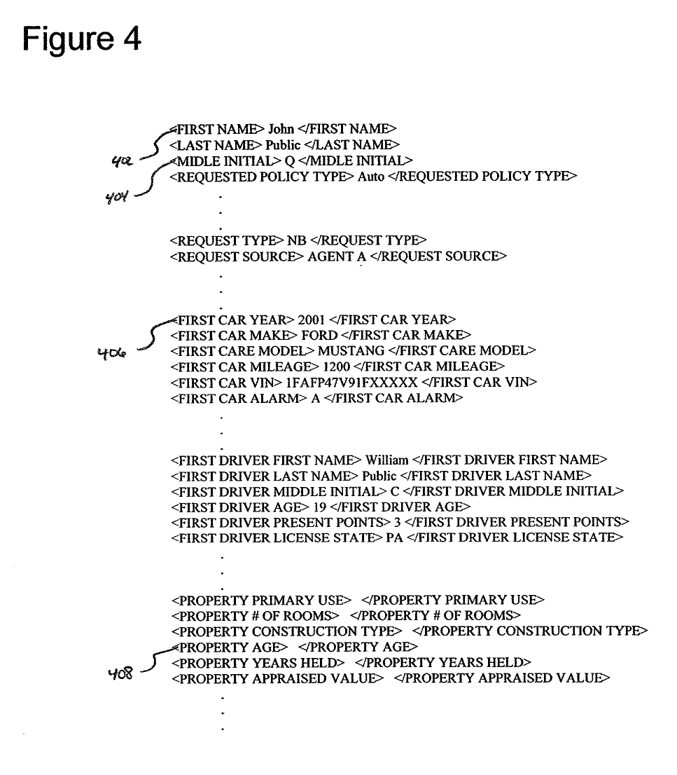

FIG. 4 is a code diagram illustrating an exemplary code format for use in the present invention. Tagged field formats, such as HTML, XHTML or XML, allow the provision of data fields that have tags associated therewith. A schema for tag and field association may be published, such that the meanings of tags and fields may be disseminated across applications. For example, an application information block for the present invention formatted in HTML is shown in FIG. 4. The format may provide tags (402, 404, . . . ) for all fields which may be considered upon analysis of an application information block. For example, the block may contain a tag 406 for identifying the year of manufacture of a first car, wherein the requested policy type is automobile liability insurance. The block may also contain tags or fields for identifying characteristics for property, such as property age 408, should the requested policy type be, for example, homeowners insurance. The fields shown in FIG. 4 are presented in order to illustrate the use of tagged fields in accordance with the present invention, and are not intended to be inclusive of all fields which may be used or necessary. The inclusion of fields is dependant upon the presence or necessity of information within the application information block. Additionally, the use of tagged fields may allow unnecessary fields to be deleted from an application information block.

Once the standardized data in the format of the common data structure has been assembled, the assembled application information block may be transferred to the process or processor for applying underwriting guidelines, such as rules, to the information contained in the application information block. Such transfer may be accomplished by any suitable method. For example, should standardization be accomplished at distributed sites, an assembled application information block may be transferred to an underwriting guidelines rules processor by means of an e-mail message communicated across the Internet, or by an encrypted network communication. Such an encrypted communication may be unencrypted at the rule server, such as through the use of public/private keys at the registered intake and at the rules server. Selection of a specific transfer method is dependant upon the actual architecture utilized to accomplish the process of the present invention.

Each rule for use in the present invention may include a formatted rule suitable for review by personnel responsible for rules maintenance, which formatted rules may include, for example, manually editable code, and an executable rule associated with each formatted rule. The formatted rule may include fields, such as editable fields, identifying characteristics of the rule, as well as parameters relevant to application of a rule, which parameters may take the form of variables until receipt of applicant information. The executable rules include the executable, computer-readable portion of a rule. For example, a rule regarding the number of points a driver is allowed to have on a license, and still be considered insurable, may be formed by a formatted rule such as shown in FIG. 5B, while the executable rule is integrated within executable code for accomplishing application of rules to an application information block.

Rules may be written such that the rules are consistent with a third-party processor. The formatted and executable rules are preferably written to express concepts contained in underwriting guidelines. Expression of the underwriting guidelines may be accomplished by developing a set of discrete business rules, each of which test a specific characteristic of application information, i.e. a parameter, for suitability with criteria desired by an insurer. Each discrete business rule may then be implemented by the creation of a formatted rule and an associated executable rule. The executable rule may contain the logic associated with the business rule, while the formatted rule may be used to provide an understandable expression of the parameters associated with the business rule. For example, a business rule for an auto policy may be that an insurer will not insure cars older than 20 years. The logic of such a business rule may be expressed as:

if ((PRESENT YEAR−FIRST CAR YEAR)>PARAMETER) then FLAG=D

if a “Do Not Insure Result” rule is being tested,

if ((PRESENT YEAR−FIRST CAR YEAR)=PARAMETER) then FLAG=R

if a “Refer” flag is being set, or

if ((PRESENT YEAR−FIRST CAR YEAR)<PARAMETER) then FLAG=I

if a “Insure” flag is desired.

The logic associated with the “Insure” flag may be obviated, since, in the absence of a “Do Not Insure” or “Refer” flag, the default result must be “Insure.” The illustrated logic would consider the year of a car as provided in an application information block (as in the <FIRST CAR YEAR> 406 field shown in FIG. 4) against the present year, and if the car was greater than “parameter” years old, return a flag having a value indicating “do not insure”.

In order to accomplish the logic as shown, an executable rule would need to reference a location to identify the value of “PARAMETER” in order to apply the business rule. By incorporating the value of PARAMETER into a formatted rule, the value of PARAMETER could be set by personnel having no knowledge of the programming language required to accomplish the logic, and without requiring the executable rule to be recompiled. Additionally, PARAMETER may refer to a memory address, wherein, upon receipt of applicant information, standardization includes parsing the correspondent information item into the memory address, and wherein accessing of the memory address thereby accesses the necessary information item.

In an embodiment of the present process, a third party rule engine known as BLAZE from HNC Software may be utilized. BLAZE may be used to develop the executable rules and formatted rules. Once the executable rules have been built, the executable rules may be deployed on a rule server, such as a rule server running BLAZE. The formatted rules may be deployed on a rule server, or on another server in communication with a rule server, for ease of access to parties authorized to change or update rule formats. When an application information block is received by the rule server, the rule server identifies executable rules to be applied against the information contained in the application information block. As identified executable rules are applied, parameters may be invoked from the formatted rules.

State specific rules may be applied through the use of the present invention, such as, for example, for policy issuance selected from at least two states. For example, some states may have only policy level tiering, while other states may have a plurality of both Policy and Vehicle tiering rules. In such an embodiment, the execution of the rule that assesses state of request will cause variation in the execution of the policy-based rules. Thus, the application of certain rules in the present invention may be dependent on the execution of certain other rules in the present invention. Thus, the rules of the present invention may be hierarchical, and the dependent rules may be applied in parallel as the independent rules are executed.

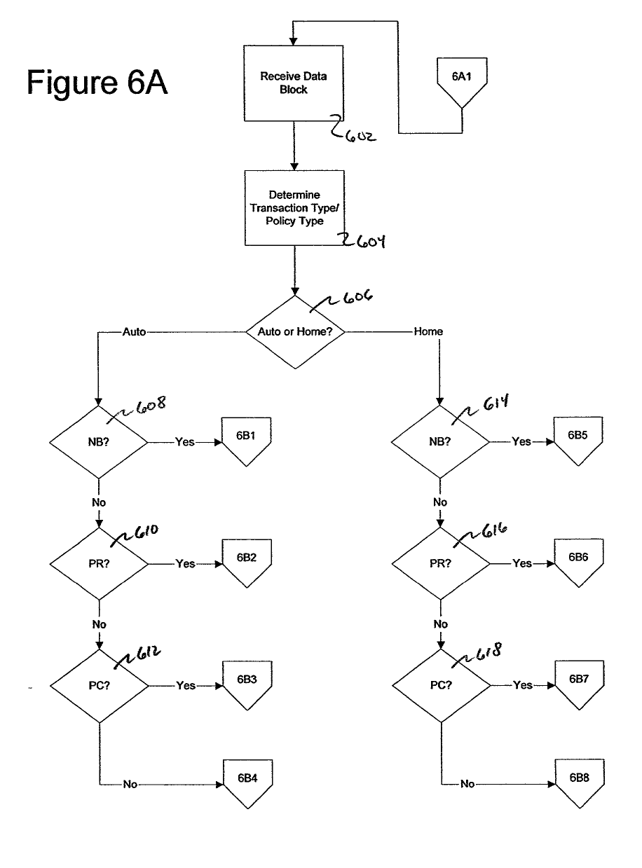

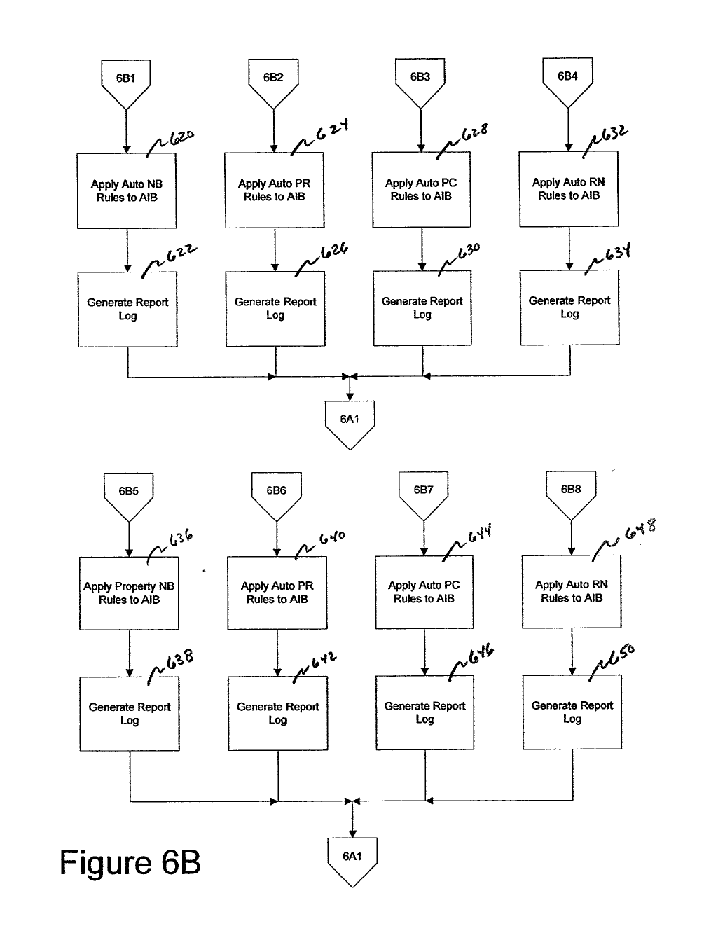

FIG. 5A is an exemplary database illustrating exemplary formatted rules for a homeowners determination. It will be apparent to those of ordinary skill in the art that a variety of interfaces may be provided for the entry of the data illustrated in FIGS. 5 and 6, and all such interfaces and data entry methodologies are intended to be within the scope of the discussion herein. Each rule may include a plurality of fields, shown in the figure in tabular form, wherein each field is represented in a column. Each individual rule is illustrated in the figure in a single row. Use of the row and column organization allows rules to be contained within a spreadsheet, or similarly organized database format, thereby allowing sorting or editing of the rules based on individual fields. For purposes of the following description regarding FIG. 5A, a formatted rule may be considered to be the aggregate of the fields of a row within the table. Although some of the illustrated fields may not be necessary to describe an underwriting guideline, fields may be added to the formatted rule, for example, to assist in administrative tracking of the rule.

The first column may represent date fields (502, . . . ) in a date column 502. Each field within this column may be used to indicate a date when the formatted rule of which the field is a member was updated last.

The second column may represent version fields (504a, . . . ) in a version column 504. Each field within this column may be used to record the number of changes that have been made to the formatted rule of which the field is a member from the initial definition of the formatted rule.

The third column may represent rule number fields (506a, . . . ) in a rule number column 506. Each field within this column may be used to identify a rule number for a formatted rule of which the rule number field is a member. Individual rule numbers may be a running sequence number maintained for each formatted rule. It is not necessary that formatted rules have sequential rule numbers, as sequential numbering would be non-operable in an instance wherein new rules were introduced between two existing rules, such as to maintain logical grouping of the formatted rules. Rule numbers may be utilized to associate formatted rules with executable rules.

The fourth column may represent rule name fields 508a in a rule name column 508. Each field within this column may be used to indicate a common name for a business rule associated with the formatted rule. Individual rule names may be selected to allow easy identification of the subject of an associated rule.

The fifth column may represent description fields (510a, . . . ) in a description column 510. Each description field may be used to record a description of the formatted rule with which a description field (e.g., 510a) is associated.

Fields may be used to identify the applicability of a formatted rule to an application information block. For example, in FIG. 5A, five columns are illustrated as representing applicability 512 fields. The first applicability column 514 may represent policy type identifier fields (514a, . . . ). The second applicability column may represent 516 represent state applicability fields (516a, . . . ) The third applicability column 518 may represent company representative fields (518a, . . . ) while the fourth 520 and fifth 522 applicability columns may represent tier applicability fields (520a, . . . ) and (522a, . . . ). Although, for purposes of explanation, the applicability columns are shown having specific relevance, the fields may be used as necessary for any applicability consideration, if the field use is compatible with required application of the formatted rule to application information. For example, in an applicability column normally used for identifying an intake source (such as column 518), an insurer rule limiting the number of rooms that a house in a given geographic region may contain while remaining eligible for insurance may be indicated by the city name at the intake source. Accordingly, application of a particular rule could thus be to limited to all application information blocks for requests from a specifically identified city or cities.

The ninth and tenth columns (520, 522) illustrated in FIG. 5A show an exemplary embodiment of tiering. The tier applicability column is illustrated as blank, since it may be used in conjunction with other policy types having tiering sub-sets, such as the automobile policy rules shown in FIG. 5B and discussed further hereinbelow. Wherein an applicability field is without relevance to a formatted rule, the field may be left blank, or used for an alternate purpose.

A typical applicability determination may be made based on the policy transaction requested. Underwriting rules for pre-existing customers may be varied from underwriting rules for new applicants. For example, when considering an auto policy, a resubscriber may be allowed to have a higher number of violation points than would be tolerated for a new applicant. Transaction type indicators may be identified using four columns with yes/no indicators, for example. A yes value would indicate applicability of a rule to an application information block, while a no value could be used to indicate that a rule was not applicable to an application information block. The use of multiple transaction type columns allows compression of transaction type rules applicability, such that a formatted rule and its associated executable rule would apply to more than one transaction type.

A more complex transaction type indicator may also be implemented. For example, an ‘R’ in the transaction field for a rule may be used to indicate that a rule is a referral rule. As an example, where an R is contained in a transaction type field, all new policy requests from a specific state may require underwriter consideration, or may be referred to a separate level of the rules hierarchy, as discussed hereinabove.

The fifteenth column may represent parameter fields (540a, . . . ) in a parameter column 540. The parameter fields may contain a parameter value for an executable rule. Although the presently illustrated embodiment shows the use of a single parameter field, multiple parameter fields for a formatted rule may be established. For example, wherein a business rule is dependant on more than one value, multiple parameters may be provided such that an executable rule may utilize and/or balance and/or compare the more than one parameter. Such a situation may occur in an embodiment wherein multiple insurance credit score levels are considered during a determination. Additionally, state, tier, effective date and expiration date may be parameters to the rules, and parameter values may be allowed to vary for each tier in a selected state.

The sixteenth column may represent comment fields (542a, . . . ) in a comment column 542. Comment fields may be used to provide a convenient place to record notes associated with a formatted rule.

The seventeenth column may represent message fields (544a, . . . ) in a message column 544. The message fields may contain a message to be generated should a rule be met. Such a message may include, or may be in addition to, a flag set to indicate that the rule was met.

The eightteenth column may represent action fields (546a, . . . ) in an action column 546. The action fields may be used to indicate the flag to set if the rule is met. For example, wherein a test is for maximum allowable points for an auto policy, exceeding the maximum value may result in the setting of a “do not insure” flag. This column may indicate an action that may be generated in addition to the setting of a flag. In addition to “do not insure” and “refer” flags, “technician” flags may be implemented to indicate a problem with application of a rule, such as an unavailable application information characteristic. Additionally, the absence of an action code can be used to indicate a default action. A default action may be an action to occur if the rule is not met.

Other fields and columns, not shown, may also be implemented, as will be apparent to those skilled in the art. A tiering field may be included in order to allow actions related to tiering to be implemented, in addition to the setting of basic action codes. Alternatively, tiering fields may be accomplished using more complex action codes in the action field, for example.

As rules are applied, the process preferably creates a report log regarding the suitability of an application information block under the rules. As noted above, application of a rule may yield an “insure”, “do not insure”, “refer”, or “technician flag” based upon the results. These action codes may be written to the report log, although in the case of an “insure” determination, no entry need be written if “insure” is used as a default.

User interface screens may be developed to manage rule parameters. Interface screens may allow the changing of values for a predefined set of parameters defined for a rule. Network, such as internet or intranet, interface screens employed in the interface may utilize JAVA, for example, and may be used to locally or remotely maintain and manage rule parameters. Alternatively, interface screens may include a standard spreadsheet program presenting formatted rules to a user in row and column format. Dependent upon the parameter type, a business user may be able to select a valid parameter from the list of values, such as from a drop-down menu of available parameters, or enter a value for the parameter, over the interface, for example, which selected or entered value is then converted to the standard format for comparison with the rules as discussed hereinabove.

FIGS. 6A and 6B are flow diagrams illustrating an exemplary process for applying underwriting rules to standardized data in an insurance sales process. When an application information block is received 602 by a rule server, as shown in FIG. 6, the process may first determine 604 a transaction type and policy type associated with that application information block. For example, if it is determined 606 that the policy type is an auto policy, the process may next determine if the application information block has a new business (“NB”) transaction type 608, and if it is determined 606 that the policy type is a home policy, the process may next determine if the application information block has a new business (“NB”) transaction type 614. If a NB transaction type is indicated, rules associated with new business transactions for auto policies may be applied 620 against the information contained in the application information block. Once the relevant rules have been applied, a report log identifying the results of the application of the rules to the application information block may be generated 622. Alternatively, the report log may be generated while each rule is applied, such that the generation of entries into the report log occurs upon completion of each asserted rule.

The process, in the simplified illustration shown, may test for application types until each application information block is identified as being within a type, and relevant rules are applied against the application information block. Expert systems may be implemented within the shown dissemination pattern to reduce the number of rules which need to be applied against an application information block, such as application of most frequently met rules at the beginning of the application of rules, with application termination upon achievement of a do not insure result. Alternatively, rules which, when applied, generate a particular flag, may be passed to an alternate path, such as a next level in a hierarchical path, for additional analysis above the first level analysis. This hierarchical processing may occur simultaneously, upon assessment of the preselected flag, with continued processing at the first, or at a lower, hierarchical level.

As noted above, application of rules to an application information block may result in the setting of flags associated with application of the rules, as well as indicate messages associated with the outcome of the rules application. In other words, the rules application may output flags and flagged items, or may associate each set flag with an explanation, or message, regarding that set flag, and the explanation and the flagged item may thereby be output. This flag and message may be performed, by example, as discussed hereinabove, or via the use of, for example, a relational database that associates a given flag with a given message. The end result of the rules application may thus be a log containing identification of each exception generated by application of the rules. Such a log may employ a sequential listing of flags and messages resultant from exceptions, such as:

| Rule | Flag | Message |
|---|---|---|
| 1.2.2.3 | R | Maximum Points Within Referral Range |
| 1.3.5.8 | R | Not at Fault Accident Identified |
| 1.6.9.4 | R | More Cars than Drivers Identified |

In the illustrated report log, only referral flags were set, such that the application information block could be forwarded to an underwriter for further consideration.

Report logs associated with application information blocks may be filtered to segregate the application information blocks into categories. The categories may correspond to the action items, with one category being “insure”, one category being “do not insure”, one category being “technician flagged”, and one category being “refer,” for example. Alternatively, similar messages or flags may be similarly grouped, such as all flags related to prior accidents.

Wherein a “do not insure” flag was set, such as in a report appearing as:

| Rule | Flag | Message |
|---|---|---|
| 1.2.2.3 | D | Maximum Points Exceeded |
| 1.3.5.8 | R | Not at Fault Accident Identified |
| 1.6.9.4 | R | More Cars than Drivers Identified |

processing of the application information block may be forwarded with a negative response regarding insurability. Alternatively, if a worst available tier was not tested, such as when sequential tiering is implemented, a preliminary tier for the application information block could be reduced one or more grade levels, and the application information block might then be resubmitted for rules application within the reduced preliminary tier.

If parallel tiering is implemented, rules for each possible tier may be applied to the application information block, resulting in multiple sets of output records. Alternatively, rules may be interdependent, such that rules for each tier are applied only in the instance wherein the next higher tier is failed. Such results could be organized by tier to thereby allow for ease of consideration of the application in the best tier for which only referral flags were set. For example:

| Tier | Rule | Flag | Message |
|---|---|---|---|
| High | 1.2.2.3.1 | D | Maximum Points Exceeded |
| High | 1.3.5.8.1 | R | Not at Fault Accident Identified |
| High | 1.6.9.4 | R | More Cars than Drivers Identified |
| Std. | 1.2.2.3.2 | R | Points Within Refer Range |
| Std. | 1.3.5.8.2 | R | Not At Fault Accident Identified |
| Std. | 1.6.9.4.2 | R | More Cars than Drivers Identified |
| Low | 1.6.9.4.3 | R | More Cars Than Drivers Identified |

would illustrate a report log wherein parallel processing of business rules and tiering resulted in the “high” tier yielding a “do not insure” flag, while the “standard” and “low” tiers resulted only in the setting of “refer” flags. In such a situation, the associated application information block is preferably transferred to a hierarchical underwriter, such as a manual underwriter, for further consideration, or to a secondary, tertiary, or other, hierarchical automated level for more specific review by hierarchically more specific rules. This embodiment may thereby minimize processing time by first limiting assessment of an application to the maximum allowable tier, and by then limiting the application of secondary and tertiary hierarchical rules to only necessary cases. The hierarchical underwriter may determine that the application information block was insurable at the “low” tier, and append the report log or application information block to reflect this determination. Alternatively, the underwriter could issue a “do not insure” response to the application information block. Simplistically, the responses could be implemented simply by changing the flag from “R” to “I”, (“insure”) or deleting offending report lines from the report log. By using an over-ride code, such as “I”, however, the utility of the report log as a means for tracking results could be maintained.

An application information block to which the rules have been applied resulting in either “insure” flags or “insure” by default may be forwarded into a tiering process for handling of any tiering issues. An application information block to which the rules have been applied resulting in “do not insure” flags may be reported to an entity responsible for intake of the application information block, or may be re-tiered if a lower tier is available under which the policy could potentially be written. Alternatively, if multiple tiers are assessed during application of the rules, the application information block may be reported as “insure under a lower tier”.

An application information block to which at least one “refer to technician” flag has been assigned may be referred to a technician for resolution of the difficulty, before being reprocessed through the rules.

An application information block having “refer” flags set, but no “do not insure” or “refer to technician flags” set, may be forwarded to a hierarchical underwriter for resolution of any “refer” results. Alternatively or additionally, an application for which a first chosen tier resulted in a “do not insure” flag may be transferred to a hierarchical underwriter if application of rules associated with a lower tier resulted in “refer” flagging.

Typically, within a single sub-group to which referred application information blocks may be assigned, several hierarchical underwriters may be assigned for each sub-group available. Assignments to underwriter groups and/or sub-groups may be made, for example, by rule type in an automated hierarchy, or by agency code in a manual hierarchy. Within each sub-group of underwriters, different underwriters may have different work loads. One underwriter may be presently assigned ten application information blocks, while another is presently assigned twenty. Accordingly, a final step in referred application information block to hierarchical underwriter segregation may be to assess the workload of underwriters available in a sub-group pool, such that the application may be referred to the underwriter having the lowest workload when the application information block is segregated. Such an embodiment may additionally be operable to load share amongst multiple servers embodying hierarchical automated underwriters, or amongst multiple manual underwriters by reassigning agency codes. Such dissemination leads to increased efficiency in resolving referred information blocks, since the assigned underwriter will have the smallest backlog, and therefore may be likely to resolve the application information block soonest.

FIG. 7 is a flow diagram illustrating an exemplary process for underwriter referral which may be invoked when application of the rules hereinabove results in a “further consideration” determination. The referral process, shown in FIG. 7, may include the disseminating of application information blocks which have been assigned “refer” flags to a hierarchical underwriter for further consideration of the rule or rules which resulted in the refer flag being set. Underwriters, including hierarchical underwriters, available to consider a referred application information block may be organized based on application types, originating states, intake entity, or any combination desired and apparent to those skilled in the art, such as through the use of agency codes. Segregation of available underwriters into such sub-groups allows the underwriters to be organized with limited responsibilities. Accordingly, an underwriter assigned to review auto applications from agent A in State B would only need to be familiar with the rules for auto policies received from agent A in State B, or would need only to be programmed with a familiarity with the rules for auto policies received from agent A in State B, and accordingly would be likely to be more knowledgeable and efficient with application of the business rules associated with agent A and State B. In addition to notifying an underwriter of assignment of a “refer” flagged application information block, an intake source or applicant may additionally be notified of further processing associated with the referral.

As shown in FIG. 7, if it is determined 702 that a “D” flag, corresponding to not insure, is set in each possible tier, an application information block may be forwarded for a DO NOT INSURE response.

If it has been determined that a tier without “D” flag exists, it may be determined 704 whether any “R” or “refer” flags have been set. If no “R” or “refer” flags have been set, the application information may be forwarded for generation 724 of a response indicating insurability.

If it is determined 704 that refer flags have been set, a referral process may successively determine a relevant intake source, state, and policy type to correctly assign the application information block to a correct underwriter, such as one assigned to handle that intake source, state, and policy type.

It will be apparent to those skilled in the art that sorting into specific underwriter or group may be based on any characteristic or combination of characteristics that is deemed to be preferred based on specific implementations of the present invention. Accordingly, the discussion hereinabove is merely illustrative.

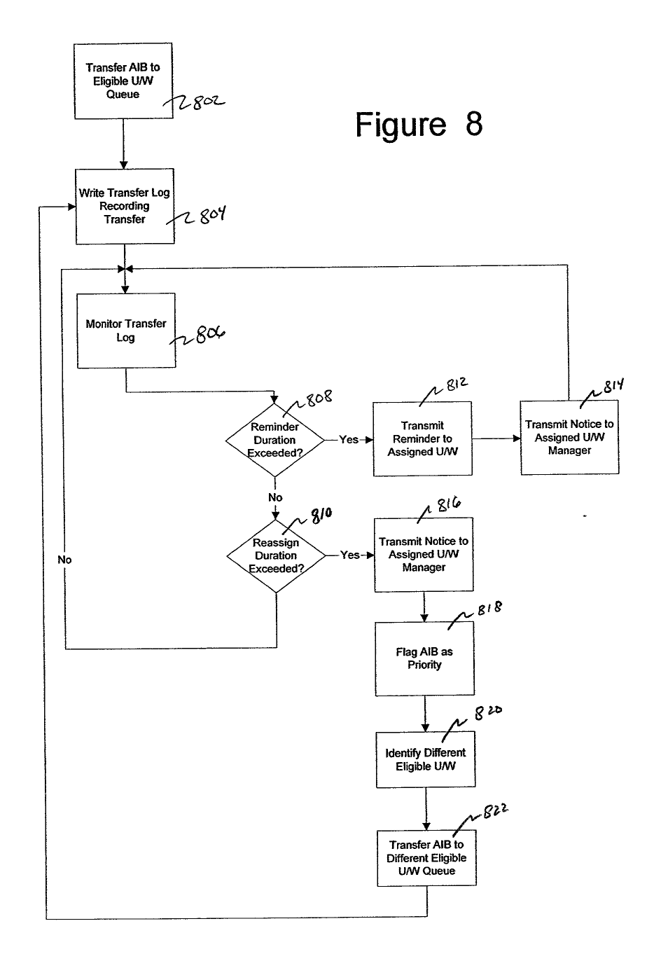

FIG. 8 is a flow diagram illustrating an exemplary process for underwriter review escalation in an insurance sales process. Within an underwriter pool, different underwriters, manual or automated, may have different circumstances. One underwriter may be assigned multiple application information blocks requiring complex considerations for resolution, while another has only applications requiring simple consideration before resolution. Alternatively, one manual underwriter may be out sick, or on vacation, or one automated hierarchical underwriter may be inoperable due to technical failure or maintenance. Such conditions could result in application information blocks languishing, resulting in unacceptable delays in processing. Accordingly, a retasking process, such as that shown in FIG. 8, may include referral to a managerial level, and may be implemented to identify and re-assign application information blocks when such application information blocks are not processed within a given time.

For the purposes of the present description, each underwriter sub-group pool may have an organizational hierarchy, either automated or manual, within the pool, such that at least one manager or programmed task manager may be assigned within an underwriter sub-group pool. The actual organizational hierarchy may likely be determined based on the number of underwriters, or number of servers or automated hierarchical levels, in the sub-group pool, such that one sub-group pool may have intermediate levels of managers or task managers, while other sub-group pools may report directly to, or may share, a manager or task manager. The manager or automated task manager has knowledge of activities within a given group or sub-group, and has an ability to re-assign or reallocate workload within the managed group or sub-group, in accordance with timing information accessible to the manager or task manager. The retasking process may monitor the application information blocks which have been assigned in order to observe and identify application information blocks that have been in a particular queue for an excessive period of time.

For example, in a manual processing system, if the underwriter is unavailable because the underwriter is not in the office, the policy system may forward rules-associated messages to another underwriter. If an underwriter does not act within a pre-defined number of days, an automatic reminder may be generated. This reminder may additionally be forwarded to a superior. Alternates to the named underwriter may also be notified based upon accessible contact information available for lookup by the policy system. This continuous tracking of the underwriting status of referrals is herein termed escalation. Use of this process ensures that a policy exception that was referred to an underwriter is handled expeditiously.

FIG. 8 illustrates an example of an escalation process. A transfer log may be generated 804, recording when and to whom an application information block is forwarded for further consideration. The transfer log may also contain records indicating that a hierarchical manual or automated underwriter, or technician, if applicable, has completed review of the application information block.

The transfer log may be monitored 806 to determine the time period for which an application information block has been pending in a queue. If it is determined 808 that a first duration has been exceeded, a reminder may be sent noting the presence of the application information block, or a query may be sent to assess system operability. Additionally, a notice may be sent 814 to a manager regarding the application block, and/or the application information block requiring reconsideration may be transferred 822 to a different eligible underwriter.

Escalation procedures for technician review of an application information block may be accomplished similarly to the escalation based on underwriter referral discussed hereinabove. A technician, as used herein, includes an automated technician, such as at least one software patch that seeks out and endeavors to patch software and server problems, and/or a manual technician. The assignment of a technician to a refused application may be based on state, policy type, and intake source criteria, or may be based on the basis of the application refusal. In the instance wherein an application refusal is based on the absence of information in an application information block, a specific technician responsible for ensuring compliance of application information blocks may be assigned as a feedback loop for ensuring compliance of application information block adequacy. Alternatively, if a refusal is based on an inability to apply a business rule to available information, the refusal may be referred to a technician responsible for implementing business rules, such that a feedback loop is provided for the correctness of logic applied in particular instances. It is thus preferable that the technician be enabled to communicate with a specific intake source directly in order to ensure adequacy and correctness of intake. Further, as with underwriter escalation, technician escalation may be based on an organizational hierarchy within a technician organization. Escalation may be based on delays in resolution of a technician referral, such as based on a reminder or a time duration.

Following the performance of the steps of the methodology discussed hereinabove, a response may be generated to the applicant, or to the intake. Transmission of the response may be accomplished by a wide variety of means, including the e-mail transmission of a formatted message to the applicant or intake source, and/or a network based transmission over, for example, the internet, wherein an applicant may be assigned a user ID and password, or a cookie, to allow accessing and re-accessing of, for example, a web site containing the results. In an embodiment wherein a web site is used, an applicant or intake may be provided with a reference number in the case of a positive result, such that the applicant can call the insurance company to gain a rate quote, or to obtain a pre-approved policy. Alternatively, an automated rate quote based on the application information block may be determined, and/or a sample policy may be generated, such as in an editable PDF file, such that the web site may be utilized to sign an applicant to a policy. Such signing may utilize an electronic signature and credit card payment, for example, to accomplish the binding of the policy, and an executed copy of the policy may then be available for download by the user, such as the agent.

Additionally, responses of the methodology of the present invention may include report logs, and those report logs may be used to generate business reports. For example, a business report for a specific intake source may provide information concerning the type of business conducted, the types of risk, the number of applications, and other metrics on the intake source. Alternatively, a business report may include the number of hits and time of day usage for, for example, an internet intake. Alternatively, a report related to an intake source may be generated that indicates the number of “hits” on a specific business rule. Thus, business rules may be adjusted based on report log tracking to thereby provide system optimization. For example, if a specific business rule is responsible for an excessive number of “refers” or “do not insures”, the rule may require modification.

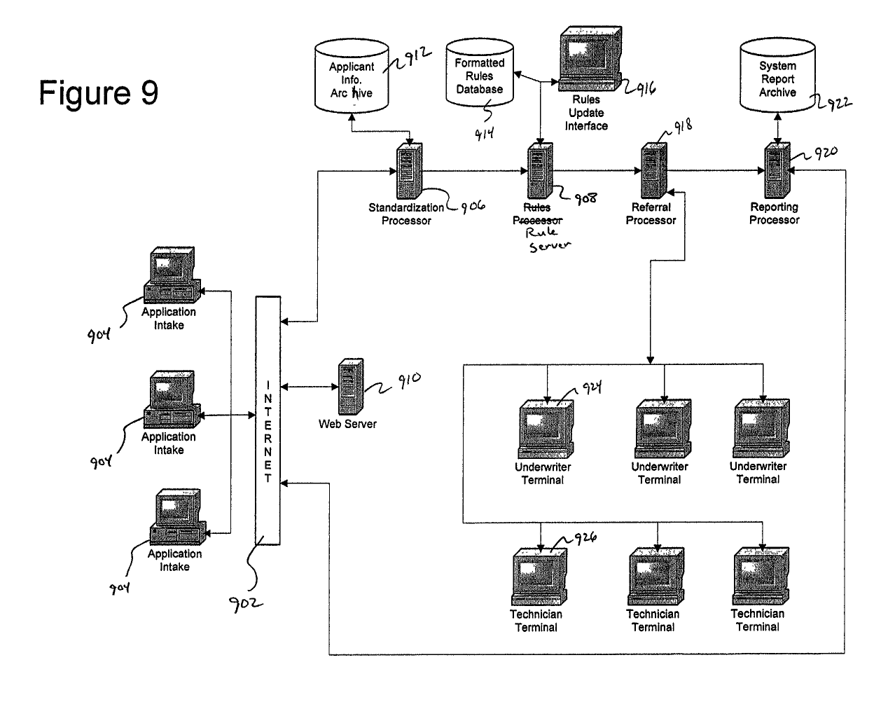

FIG. 9 is a block diagram illustrating an exemplary insurance sales system according to the present invention, and including the methodologies of FIGS. 1-8. Such a system, as exemplified in FIG. 9, may employ a network, such as the Internet 902, as a methodology of communicating information from application intake sources 904. The application intake sources 904 may include dedicated terminals provided to insurance agents or brokers, or agent or broker specific computer tools, or public or private network access points, such as home-computers of applicants. Agent or broker specific computer tools may include legacy tools, and agent or broker tools preferably include an integration with legacy tools not necessitating the replacement of the legacy tools. Once application information has been received at an intake source 904, the information may be transferred via the network 902 to a standardization processor 906.

In an exemplary embodiment, the standardization processor 906 is illustrated as a separate unit in FIG. 9. However, the standardization processor 906 may be part of a rule server 908, such that a single computer or processor may process tasks associated with an underwriting process. Alternatively, the standardization processor 906 may include a plurality of servers among which standardization processing is distributed. Such an implementation may be desirable in an embodiment wherein a sufficiently large amount of application information is to be processed so as to exceed the available output of a single server. In an embodiment wherein a plurality of servers is implemented to handle application information standardization, a router or switch may be provided to distribute application information between standardization servers.

Alternatively, an application intake source may include a web server 910 that generates interfaces to allow for applicants to provide application information to the web server 910. The web server 910 may perform the standardization, or may forward the information to a standardization processor 906, or to a router associated with a plurality of standardization processors.

The standardization processor 906 may have a database 912 of archived applicant information associated therewith, such that archived applicant information may be used to populate an application information block, or such that the archived information may be used to identify characteristics of a prior applicant that have changed subsequent to the prior application. Changed characteristics may be used to reduce rule application requirements, as discussed hereinabove. Alternatively, the archived information may be made accessible to intake sources to thereby reduce the data acquisition necessary to receive necessary application information from an applicant. If an applicant had previously provided information, the previously provided information may be used to limit intake of new information to information that was either not previously provided or that has changed since previously provided.

The standardization processor 906, as discussed hereinabove, may translate applicant information into a standardized application information block. The standardization processor 906 therefore may receive applicant information in different forms from, for example, a plurality of legacy systems, and thus preferably identifies at least one of the information source and the information type in order to correctly populate an application information block. The standardization processor 906 may also implement a data adequacy check to ensure that sufficient information has been obtained regarding an application to allow consideration of the application. The standardization processor 906 may query an intake source 904 in order to obtain additional information, if necessary.

The application information block may be forwarded to a rule server 908 to allow application of the business rules. The rule server 908 may have a database associated therewith to store rules for application. The database may be, for example, relational and/or hierarchical. Executable rules may be in a basic operating program readable by the rule server 908, while formatted rules may be stored in a formatted rules database 914, or on a rules update server, for example, for manipulation by authorized parties. Alternatively, both formatted and executable rules may be stored on the rule server 908, and a rules update interface 916 may be provided to allow access to, for modification of, formatted rules, whether stored in a separate database, or in the rule server 908. The rules update interface 916 may additionally include a customized interface.

Alternatively, a plurality of rule servers may be implemented in order to increase the capacity of the system. In an embodiment wherein a plurality of rule servers are implemented, a router or switch may be used to distribute application information blocks between the plurality of rule servers, or a queuing server may be provided to temporarily store and disseminate application information blocks between the plurality of rule servers.

A referral processor 918 may be provided to receive application information blocks and report logs from the rule server 908. The referral processor 918 may be used to determine whether application information blocks are to be forwarded to an underwriter for further consideration, forwarded to a technician for correction of a fault, or forwarded to a reporting processor 920 in the case of an “insure” or “do not insure” result. The reporting processor 920 may include a business reports archive 922 that allows report logs to be aggregated into business reports. The reporting server may forward reports regarding insurance decisions to intake sources 904 via a network, such as the internet 910, or may use any other feasible method for communicating a decision to an applicant, either directly or through the intake source.

The referral processor 918 may forward “refer for further consideration” and/or “refer to technician” application information blocks and report logs to underwriter terminals 924 and technician terminals 926, respectively, or may use, for example, e-mail to forward “refer for further consideration” and “refer to technician” application information blocks and report logs to specific underwriters or technicians, as discussed hereinabove with respect to escalation. It is noted that underwriter terminals may include servers and/or terminals for manual underwriters, or for hierarchical underwriters programmed to apply successively more specific rules to application information blocks that require clarification in light of, for example, the setting of a “refer” flag.

In an exemplary embodiment of the present invention, and dependent upon the transaction type set for a policy in the policy data, application of the executable rules may follow a specific processing flow path. For example, all executable rules that have characteristic ‘X’ associated with a specific transaction type may be implemented in that specific transaction.

For example, if the new business (NB) transaction is indicated, the rules engine may execute only rules that are applicable for the NB transaction type. This transaction type of a policy may be received as an element of the application information block. In an embodiment wherein an NB action type is specified, the process may, for example, reset the tiering for the application according to a default tier assignment. A best possible tier, or a lowest rated tier, may be initially assigned to an application. The tiers for an intake source may be pre-defined, and include the best possible, or the lowest rated, tier, which may include only a single tier, dependent upon the policy type and/or jurisdiction, as will be apparent to those skilled in the art. Policy tiering preferably stops at the lowest possible tier for a policy. If an application information block is not assigned in a higher tier, a lowest available tier may be assigned to the application information block.

The rules engine may then execute all executable rules that are applicable for that policy state, company and tier. The process may incorporate any referral messages that are generated the report log. The process may generate tier and referral messages as a response to an application information block. In order to assist in referral resolution, referral messages may be grouped by tier, for example.

In an additional exemplary embodiment, a PC transaction may include rules that are applicable for Policy Change (PC) transaction. If a PC transaction is indicated, the process may apply only rules that are applicable for the PC transaction. Optionally, there may be no re-tiering for an application information block while executing PC rules. Additionally, as a PC policy is in force, only referral messages may be generated by the process.

In the PC transaction, in order to reduce processing, only rules associated with changed data fields within the application information block may be applied. Such a process may identify changed data fields, as well as rules associated with the changed data fields, and/or may allow an applicant or other intake to direct the fields that have changed. The process may select a rule for execution only if data for that rule has changed from the existing policy master. If a pre-existing data value and a new data value are substantially equivalent, the rule engine may elect to skip re-application of the rule. If the re-application of rules to the PC transaction generates only referral messages in the same tier as the existing policy, all the referral messages may be grouped under the current policy tier.

In an additional exemplary embodiment, a Pre-Renewal (PR) transaction may include application of rules that are applicable for Pre-Renewal transactions. Optionally, a re-tiering of a policy may be barred while a PR application information block is considered. In such an embodiment, only referral messages may be generated by the system.

In an additional exemplary embodiment, a renewal transaction (“RN”) may include application of rules that are applicable for Renewal transactions. In an embodiment wherein an application information block is considered under the RN rules, the process may attempt to re-tier an application information block to a tier better, or worse, than the current tier. The process may thus assign the best possible tier to the renewed policy. Tiering messages generated may be grouped by tier in order to assist an underwriter with consideration of a referral or referrals.

For example, while considering a PC transaction, the process may execute PC rules pursuant to either NB or RN, dependent upon a policy term identified in the application information block. If the policy term of the policy is less than a specific duration, the process may consider the application information block under NB rules, and tiering may be barred for policy tiering states even though tiering might be performed if the transaction were a true NB, rather than a PC. Specific duration coding may be implemented using differing codes within a PC action field, wherein different fields are utilized for each of the NB, PR, RN, and PC actions. For example, application of a rule to an application information block having less than a specific duration may be indicated by an “L”, while application of a rule to an application information block having greater than a specific duration may be signified by a “G.”

In such an embodiment, wherein the action code of a rule is “G”, the process may apply rules to the PC application information block as in a Renewal, i.e., the rule server may execute all applicable RN rules. Tiering may be barred for policy tiering states, although tiering might be performed if the transaction were a true RN.

Further, identification of an application information block as either “L” or “G” may be determined during standardization of the application information block. Though the PC transaction may follow either NB or RN rules, all NB or RN rules may not require consideration for a particular evaluation. Only those rules having an ‘L’ or ‘G’ characteristic for the PC transaction may require consideration. For example, if a PC action field for a given rule has an “L” or “G” therein, then only rules having an check in the NB or RN applicability field, respectively, need be applied. Table 1 illustrates such an embodiment.

TABLE 1
Rules Assertion

| NB | PC | RN | Comments |
|---|---|---|---|
| X | L | X | Consider for NB or RN |
| | | | terms |
| X | G | | Do not consider NB, |
| | | | Apply PC |
| | L | X | Consider for RN, PC |
| | | | Rules |
| | G | | PC rules |

It will be apparent to those skilled in the art that various modifications and variations may be made in the apparatus and process of the present invention without departing from the spirit or scope of the invention. Thus, it is intended that the present invention cover the modification and variation of this invention provided the modification and variation fall within the scope of the appended claims and equivalents thereof.

We claim:

1. A method of centralized automated underwriting of an insurance policy in accordance with a plurality of applicant information, comprising:
intaking the plurality of applicant information;
normalizing the plurality of applicant information;
applying, in parallel, and to the normalized plurality of applicant information, at least two primary executable rules, wherein the normalized plurality of applicant information comprises at least two parameters for the at least two primary executable rules;
generating a report log of results of said applying, wherein the report log includes at least one flag of at least one of the plurality of applicant information;
referring, in accordance with the at least one flag, of at least one of the flagged at least one of the plurality of applicant information, to at least one hierarchical underwriter; and
forwarding a response to the intake in accordance with a result of said referring.

2. The method of claim 1, wherein said intaking comprises intaking by at least one independent sales agent.

3. The method of claim 1, wherein said intaking comprises intaking by at least one remote networked site.

4. The method of claim 3, wherein said intaking comprises intaking into at least one applicant database at the remote networked site.

5. The method of claim 1, wherein the at least one flag includes at least one do not insure flag.

6. The method of claim 5, wherein, upon detection of the do not insure flag, said referring comprises referring to a policy rejector, and wherein said generating a response comprises generating a denial response.

7. The method of claim 1, wherein the at least one flag includes at least one refer for further consideration flag.

8. The method of claim 7, wherein, upon detection of the refer for further consideration flag, said referring comprises referring to a hierarchical automated underwriter, further comprising:
applying by the hierarchical automated underwriter to the normalized plurality of applicant information correspondent to the at least one refer for further consideration flag, at least one secondary executable rule, wherein the normalized plurality of applicant information comprises at least one parameters for the at least one secondary executable rule;
generating, by the hierarchical automated underwriter, a report log of results of said applying at least one secondary executable rule, wherein the report log includes at least one selected from the group consisting of at least one secondary flag of at least one of the plurality of applicant information, and a final response;
if the report log includes at least one secondary flag, referring, in accordance with the at least one secondary flag, of at least one of the secondary flagged at least one of the plurality of applicant information, to at least one additional hierarchical underwriter;
if the report log includes a final response, forwarding the final response to the intake.

9. The method of claim 8, wherein said applying, and said applying by the hierarchical automated underwriter, are in parallel.

10. The method of claim 8, wherein said applying, and said applying by the hierarchical automated underwriter, are in series.

11. The method of claim 8, wherein said applying at least one secondary executable rule comprises changing a preliminary tier to a lower tier, and re-applying at least one primary executable rule after said changing.

11. The method of claim 7, wherein, upon detection of the refer for further consideration flag, said referring comprises referring to a hierarchical manual underwriter.

12. The method of claim 1, further comprising determining sufficiency of the applicant information provided, and requesting additional applicant information if an insufficiency is determined.

13. The method of claim 1, further comprising determining discrepancies in the applicant information.

14. The method of claim 13, wherein said determining discrepancies comprises comparing the applicant information to a plurality of stored applicant information.

15. The method of claim 1, further comprising tiering the application information wherein the response forwarded is an insure response.

16. The method of claim 15, wherein said tiering comprises comparing, by a comparator, of the report log to a tier characteristic database, to determine a highest service level to be associated with the applicant information.

17. The method of claim 15, wherein the applicant information comprises a preliminary tier, and wherein said tiering comprises comparing, by a comparator, of a preliminary tier to a tier characteristic database, to determine whether the preliminary tier is a highest service level to be associated with the applicant information.

18. The method of claim 1, wherein said intaking is from an insurance agent.

19. The method of claim 1, wherein said intaking is from an applicant.

20. The method of claim 1, wherein said intaking comprises querying for specific portions of the applicant information.

21. The method of claim 20, wherein at least a portion of the applicant information is accessible in a preexisting policy, accessing the at least a portion of the applicant information accessible in the preexisting policy, and autofilling the at least a portion of the applicant information accessible in the preexisting policy in at least partial satisfaction of said querying.

22. The method of claim 1, wherein said normalizing comprises receiving the applicant information in a secure format, and unencrypting the applicant information using a key correspondent to the secure format.

23. The method of claim 1, wherein said normalizing comprises parsing the applicant information.

24. The method of claim 23, wherein said normalizing further comprises assembling the parsed applicant information into a common format data structure.

25. The method of claim 1, further comprising maintaining archived applicant information for preexisting applicants, and updating the archived applicant information with the applicant information upon said normalizing.

26. The method of claim 1, further comprising assessing which of the at least two primary executable rules are applicable to the applicant information, according to the applicant information, prior to said applying.

27. The method of claim 1, further comprising assessing a transaction type prior to said applying.

28. The method of claim 1, further comprising assessing an application type prior to said applying.

29. The method of claim 1, further comprising relating, in a database, at least one of the at least one flag with at least one message in the report log.

30. The method of claim 1, further comprising assessing a workload of at least two of the hierarchical underwriters, and wherein said referring comprises referring to the one of the at least two hierarchical underwriters having a lowest workload.

31. The method of claim 1, wherein the response comprises a rate quote.

32. A centralized automated underwriter for an insurance policy, comprising:
an intake that intakes a plurality of applicant information in an intake format;
a normalizer that normalizes the intake format of the plurality of applicant information into a standard format of the centralized automated underwriter;
a rules applicator that selectively applies, to the standard format of the plurality of applicant information, and in accordance with at least two parameters of the plurality of applicant information, at least two primary executable rules;
a report generator that generates a report log of results from said rules applicator, wherein the report log includes at least one flag of at least one parameter of the plurality of applicant information, and wherein said report generator refers, in accordance with the at least one flag, at least one of the flagged at least one parameters to at least one hierarchical underwriter.

33. The centralized automated underwriter of claim 32, wherein said intake comprises at least one independent sales agent.

34. The centralized automated underwriter of claim 32, wherein said intake comprises at least one remote networked site.

35. The centralized automated underwriter of claim 34, wherein said intake comprises at least one applicant database at the remote networked site.

36. The centralized automated underwriter of claim 32, wherein the at least one flag includes at least one do not insure flag.

37. The centralized automated underwriter of claim 36, wherein said hierarchical underwriter comprises a policy rejector.

38. The centralized automated underwriter of claim 32, wherein the at least one flag includes at least one refer for further consideration flag.

39. The centralized automated underwriter of claim 38, wherein, upon detection of the refer for further consideration flag, the hierarchical automated underwriter applies, in parallel, and to the normalized plurality of applicant information correspondent to the at least one refer for further consideration flag, at least one secondary executable rule, wherein the normalized plurality of applicant information comprises at least one parameter for the at least one secondary executable rule.

40. The centralized automated underwriter of claim 39, wherein the hierarchical underwriter comprises a hierarchical report generator, and wherein a report log generated by the hierarchical report generator includes at least one selected from the group consisting of at least one secondary flag of at least one of the plurality of applicant information, and a final response;
wherein, if the report log includes at least one secondary flag, the hierarchical report generator refers, in accordance with the at least one secondary flag, at least one of the secondary flagged at least one of the plurality of applicant information, to at least one additional hierarchical underwriter; and
wherein, if the report log includes a final response, the hierarchical report generator forwards the final response to said intake.

41. A process for reducing manual consideration of insurance applications, comprising the steps of:
receiving applicant information from at least one intake source;
standardizing the applicant information from the at least one source into an application information block;
transferring the application information block to a rule server;
applying, at the rule server, a plurality of business rules to the application information block to assess insurability of an applicant associated with the application information block, said applying resulting in a determination selected from the group consisting of insure, do not insure, and refer for further consideration;
wherein, if application of said business rules results in a refer for further consideration determination, referring the application information block to an manual underwriter for manual consideration of the application information block.

42. A process according to claim 41, wherein said standardizing uses a tagged field format.

43. A process according to claim 41, further comprising the step of comparing received applicant information to archived information to determine whether the archived information should be updated based upon the received applicant information.

44. A process according to claim 43, further comprising the step of comparing the received applicant information to the archived information to determine whether the applicant may be prompted for additional applicant information based upon the archived information.

45. A process according to claim 41, wherein said rules each comprise a formatted rule associated with an executable rule.

46. A process according to claim 45, wherein said executable rules each comprise applicability information, said applicability information identifying whether the rule is applicable to the applicant information block.

47. A process according to claim 46, wherein said applicability information identifies whether an the rule is applicable to the application information block based upon whether said application information block represents a renewal of the insurance application.

48. A process according to claim 46, wherein said applicability information identifies whether an the rule is applicable to the application information block based upon whether said application information block represents a new enrollment in the insurance application.

49. A process according to claim 41, wherein the step of referring the application information block to an underwriter for manual consideration of the application information block further comprises monitoring the status of the application information block to determine whether manual consideration has occurred within a predetermined period.

50. A process according to claim 49, wherein when it is determined that manual consideration has not occurred within said predetermined period, further comprising escalating to a secondary manual underwriter.

51. A computer readable medium having thereon a plurality of instructions which, when executed by a computer process, implement the method comprising:
intaking a plurality of applicant information;
normalizing the plurality of applicant information;
applying, in parallel, and to the normalized plurality of applicant information, at least two primary executable rules, wherein the normalized plurality of applicant information comprises at least two parameters for the at least two primary executable rules;
generating a report log of results of said applying, wherein the report log includes at least one flag of at least one of the plurality of applicant information;
referring, in accordance with the at least one flag, of at least one of the flagged at least one of the plurality of applicant information, to at least one hierarchical underwriter; and
forwarding a response to the intake in accordance with a result of said referring.
